(19) United States
(12) Patent Application Publication
(10) Pub. No.: US 2009/0109666 A1
(43) Pub. Date: Apr. 30, 2009

(54) UNIVERSAL LIGHT BAR ASSEMBLY AND SYSTEM

(75) Inventor: Roman F. Striebel, Duxbury, MA (US)

Correspondence Address: BURNS & LEVINSON, LLP, 125 SUMMER STREET, BOSTON, MA, 02110, US

(73) Assignee: SUNCOR STAINLESS, INC., Plymouth, MA (US)

(21) Appl. No.: 12/252,442

(22) Filed: Oct. 16, 2008

Related U.S. Application Data
(60) Provisional application No. 60/982,890, filed on Oct. 26, 2007.

(51) Int. Cl. F21S 4/00; F21V 33/00; F21V 31/00

(52) U.S. Cl. 362/225; 362/217.16; 362/217.12

(57) ABSTRACT

A light bar assembly having a face component which includes a light source and a mounting member. The light bar assembly can be affixed to the surface of a structure by the mounting member to selectively light at least a portion of the structure or surrounding area thereof.

### CROSS-REFERENCE TO RELATED APPLICATIONS

This application claims priority of co-pending U.S. Provisional Application No. 60/982,890, filed Oct. 26, 2007, entitled UNIVERSAL LIGHT BAR, which is incorporated by reference herein in its entirety.

### BACKGROUND OF THE INVENTION

Many homeowners have looked for ways to install lights on decks, railings, stairs, fences, and a wide variety of other areas which require lighting. In the past, such lights were difficult to install and expensive to operate. In addition, such lights failed to provide sufficient illumination to satisfy current safety guidelines.

Although light-emitting diode (LED) lighting currently exists in the form of “rope lighting,” drawbacks of such rope lighting include, but are not limited to, difficulty of installation and inability to light specific areas.

### SUMMARY OF THE INVENTION

An embodiment of the invention described herein provides a light bar assembly that can be easily mounted on a variety of surfaces and is capable of directing light to particular areas. The light bar assembly includes a face bar extending in a longitudinal direction and having a pair of ends, as well as at least one opening for permitting light to pass through. A lighting system mounted within the face bar comprises a circuit board extending in the longitudinal direction and having two ends as well as wires capable of carrying electric current, and at least one light source electrically connected to the wires and to the circuit board. Finally, a mounting bar extends in the longitudinal direction and has two ends, with one part forming a connecting section, and where the mounting bar is capable of being mounted to a structure. The connecting section of the face bar and the connecting section of the mounting bar are capable of being removably interconnected to each other.

Another embodiment provides a light bar system comprising one or more light bar assemblies connected in series.

For a better understanding of the invention, together with other and further aspects thereof, reference is made to the accompanying drawings and detailed description, the scope of the invention being set forth in the appended claims.

### BRIEF DESCRIPTION OF THE DRAWINGS

FIG. 1A is an exploded pictorial cross-sectional view of the light bar assembly of this invention with portions thereof shown in exaggerated fashion;

FIG. 1B is a cross-sectional view of the mounting bar shown in FIG. 1A;

FIG. 1C is a pictorial view of the circuit board;

FIGS. 2A, 2B, 2C, and 2D are cross-sectional views of various embodiments of the light bar assembly where 2D is shown in exploded fashion;

FIG. 3A is a pictorial view of the light bar assembly of this invention mounted under a railing and connected to a power converter;

FIG. 3B is a pictorial view of the power converter as shown in FIG. 3A;

FIG. 4 is a pictorial view of the invention mounted under a railing and shown disconnected from a power converter in order to illustrate the light bar assembly in exploded fashion;

FIG. 5 is a pictorial view of an example of four light bar assemblies joined by connector plugs where two of the light bar assemblies are shown in exploded fashion;

FIG. 6 is an exploded pictorial view of a light bar assembly and a connector plug; and

FIG. 7 is an exploded pictorial view of a supply plug and a light bar assembly.

### DETAILED DESCRIPTION

The light bar assembly of the present invention provides for simplified installation and use in a wide range of applications. Its compact and aesthetically-pleasing appearance blends into a structure without being too noticeable during the daylight hours.

This invention addresses shortcomings of past systems and provides a unique design capable of new and different applications. The present invention provides a light bar assembly that is exceptionally easy to reproduce, easy to install, can be adapted to many different uses and materials. The light bar assembly also allows flexibility when a user requires light at irregular or regular intervals, is virtually maintenance free, and is able to be run at very low cost. The light bar assembly is made up of a minimum of replaceable components.

These and other objectives are achieved by a plurality of light sources mounted directly onto a circuit board that carries an electrical wire at one or both of its ends. The mounted light sources and circuit board are preferably embedded in a compound resistant to water and damage before being placed inside the recess of the light bar assembly. The mounted light sources can be orientated to a desired direction, which preferably would be downward to illuminate a railing, stairs, or other mounting surface for better visibility. If desired, the circuit board can also accommodate a light sensor, a rectifier, or other desired electronic components, and will preferably be able to be powered from either end.

The light bar assembly is made up of at least two sections that are preferably, but not limited to, extruded plastic for lower cost. The two sections can also be made by injection molding for additional features. One of the sections, called the “face bar”, is a part containing a suitable recess, whereas the other part, called the “mounting bar”, is preferably of a modified flat shape that allows it to be mounted on a surface.

The face bar, being the recessed part of the lighting system, carries the light sources, the circuit board, and electrical wires which may be connected to one or both ends of the circuit board or boards. The longitudinal edges preferably have an attaching mechanism which allows the face bar to be mated with the mounting bar.

The mounting bar is capable of being affixed to a surface by various means and has along its longitudinal edges a suitable mating mechanism adapted to accept the face bar. The mounting bar can optionally provide a suitable longitudinal recess in front or on its back that can carry and secure electrical wiring for connecting together a plurality of light bar assemblies.

The light bar, assembled as described, can optionally be closed at both ends by a supply plug, a connector plug, or other suitable component that can also incorporate a method of attaching an adjoining light bar assembly. In one embodiment, one or both ends of the light bar assembly are hollow, thus providing a suitable space for at least one such suitable component, protected from view and the elements.

The mounting bar can also be used as a stand-alone part to carry the electrical wire hidden and secured, or it can be used together with an empty face bar, without a light source and circuit board therein, to provide a uniform and matching bar assembly, one section of which would be lighted and the other section would be used to carry the electrical wire within its empty recess. In that embodiment, the empty bar can be used to hide all wiring and its ends can also be shaped into a chamfer or other shape that would allow a uniform bar to go around the perimeter of a structure, such as a hexagon, although it is not limited to this shape.

Each time an additional light bar is used, a connection with an electrical wire is required. Provided for this purpose is a commercially existing connector that does not require wire ends to be stripped.

In one embodiment, a supply plug may be used to connect a power converter to the first or last light bar. The supply plug is preferably molded to the end of an electrical wire that can then be cut at the power converter end and attached to the power converter by a pair of fasteners, preferably hidden, without the need for electrical connectors.

The power supply of the power converter is preferably shaped in such a way, although not limited thereto, so as to fit under the cover of an outdoor electrical outlet. In that case, a light sensor controlling the entire installation could be provided on a separate tail of suitable length connected to the power converter, so that the light sensor could be placed away from the covered power supply. Alternatively, the supply plug could incorporate a light sensor.

Many other combinations and shapes are possible, formed of either extruded plastic, injection molding, or otherwise shaped, and made up of one or several shapes, examples of which are illustrated in the drawings. There are also different methods for mounting the light bar, depending on the shapes chosen or the requirement of mounting to a horizontal or vertical surface.

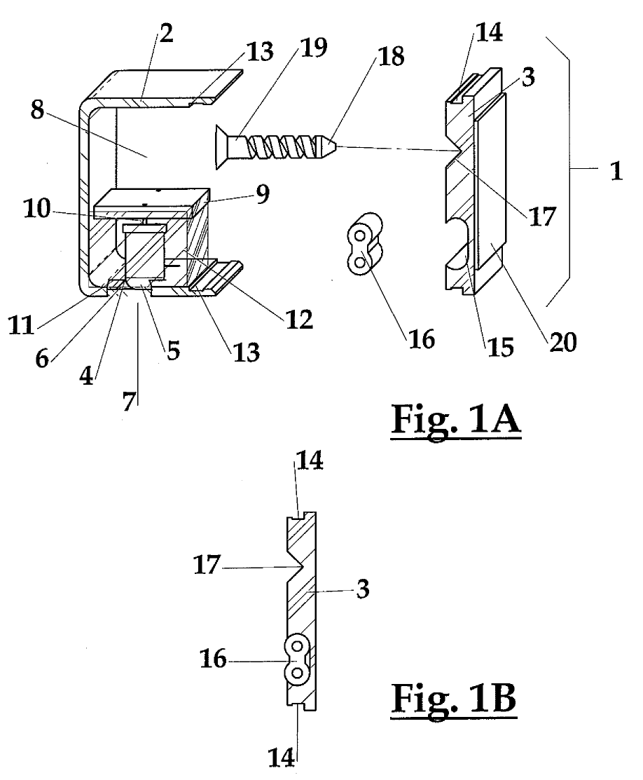

Reference is now made to the drawings provided herein, and initially to FIGS. 1A and 1B which illustrate light bar assembly 1 made up of a face bar or component 2 and a mounting bar or component 3. The face bar 2 may be channel-shaped and may have at least one hole or opening 4 which is preferably shaped in such a way as to match the diameter of a light source 5, which could be, but is not limited to, an LED, and may be chamfered 6 in such a way as to allow the light generated to freely radiate into the desired direction 7. In addition, a transparent or colored cap may be provided to cover the opening and to color the light. A hollow area 8 generated by the shape of the face bar 2 is dimensioned to contain a circuit board 9 which may be in the form of a printed circuit board onto which at least one light source 5 is mounted by its contacts 10. In the embodiment, the space 12 contained between the circuit board 9 and the lower surface 11 of the face bar may be filled with epoxy or any other commercially suitable filler material. This ensures that all electrical components and the circuit board 9 are protected against moisture or damage and also ensures that the face bar 2 is strengthened.

A suitable attaching system such as a snapping mechanism is provided in the form of a longitudinal recess and upstanding element 13 on the face bar 2 that is joinable with another attaching system, such as, for example, a longitudinal recess 14 on the mounting bar 3. By not filling the upper part of the face bar 2 with filler, it is ensured that the face bar 2 can deform sufficiently for the two parts of the longitudinal recesses 13 and 14 to engage and hold.

If so desired, the mounting bar 3 can have an additional longitudinal recess 15 into which an electrical wiring 16 can be pressed and secured. A further groove 17 could optionally be provided to locate and secure mounting screws, nails or other fasteners 18, and the shape of groove 17 can match the shape of a fastener head 19 for additional security. In another embodiment, the back of the mounting bar 3 can be coated with a double sided tape 20 or other adhesive to affix the mounting bar 3 to a desired surface with or without the use of additional fasteners.

With reference to FIG. 1C, at each end of the circuit board 9 is a pair of electrical wires 21 and a pair of electrical wires 22 which can be connected to the circuit board 9 to provide power to a light source 5, and also provide an electrical connection to adjoining light assemblies 1 by means of a suitable commercially available snap connector 23 that preferably allows connection of wires without stripping their insulation. Although a single circuit board 9 is shown in FIG. 1C, a series of circuit boards may be utilized with at least one light source connected thereto to form a series of “mini circuit boards” electrically connected together by the wires. Such “mini circuit boards” allow the face bar 2 and mounting bar 3 to take on various configurations. Any other suitable connector, such as co-axial connectors or standard connectors could also be used for this purpose.

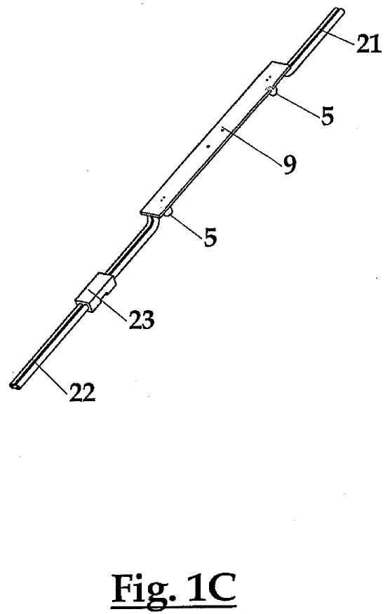

With reference to FIGS. 2A-2D, wherein FIG. 2D is shown in exploded fashion, different shapes and combinations are given for the light bar assembly 1. As shown in FIG. 2A, an embodiment of the light bar assembly could be made up of two interlocking angled components 24.

In yet another embodiment, as shown in FIG. 2B, a face bar 2 is rotated in such a way as to allow a mounting bar 3 to be mounted on the top, thus allowing the light bar assembly to be mounted in a vertical direction 28. By employing a differently shaped face bar 2 and mounting bar 3, a combination of horizontal or vertical mounting could be accomplished.

In another embodiment, as shown in FIG. 2C, a shaped component 25 can optionally incorporate a support 26 on which circuit board 9 rests.

In addition to the at least one hole 4 for the light source 5, the face bar 2 can also incorporate a horizontal through-hole 27 and/or a vertical through-hole on mounting bar 3 to accommodate selected fastener 18 for either horizontal or vertical mounting options.

In yet another embodiment, as shown in FIG. 2D, the face bar 2 has a different profile that allows a top snapping mechanism 29 to be engaged first before rotating 30 and pushing a lower snapping mechanism 31 into place. More specifically, the embodiment shown in FIG. 2D utilizes an upstanding element fitting within a recess as snapping mechanism 29 and a recess and upstanding element in conjunction with a recess as snapping mechanism 31. The snapping mechanism on the face bar 2 and mounting bar 3 may be interchanged as well within the concept of attaching the upper snapping mechanism 29 in place with rotating the face bar 2 so as to engage snapping mechanism 31. In addition, opening 4 may be located within either the bottom segment of face bar 2 or the side segment of face bar 2 to permit the light bar assembly to be mounted horizontally or vertically. The unused opening 4 would be closed if one light source is utilized. It may also be possible to use two perpendicularly disposed light sources (not shown), if desired.

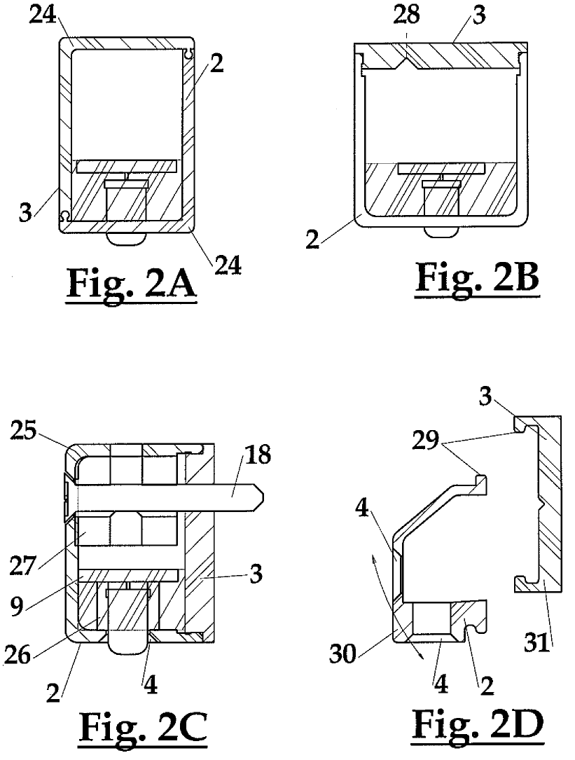

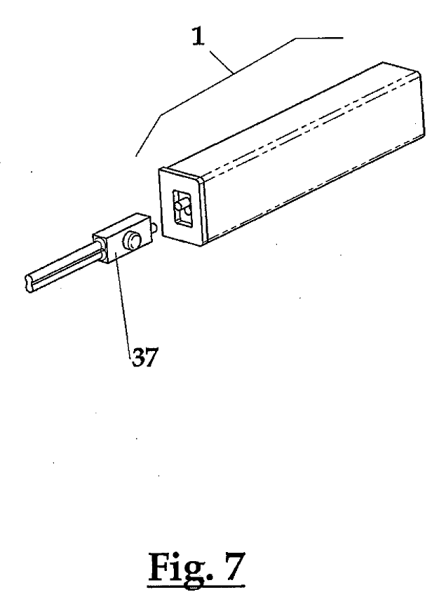

With reference to FIG. 3A, a typical arrangement of light bar assemblies 1 is shown. A power converter 32 is shown with a rear view in FIG. 3A and a front view in FIG. 3B with an optionally incorporated optical sensor 33 and is capable of being plugged into a power supply or of being battery operated. The power converter 32 may include screw-type lugs 35 or another equivalent wire connector at its protected back, onto which an electrical wire 36 powering the light bar assembly 1 is attached. In one embodiment, a snap connector 23 connects the first light bar assembly 1 to a pair of electrical wires 36 (positive and negative) coming from the power converter 32. Such an arrangement allows long electrical wires 36 to be cut to size by the installer because the cut ends will be attached to the screw-type lugs 35. A further embodiment includes a supply plug 37 and is shown in FIG. 7.

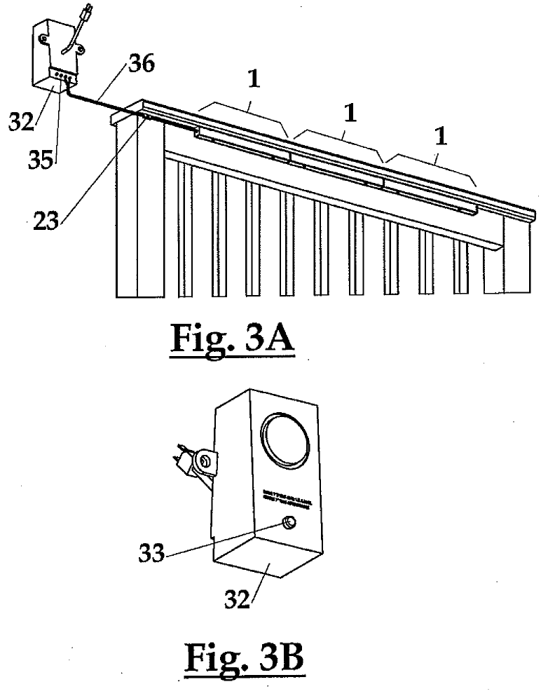

With reference to FIG. 4, the mounting bar 3 is attached to the surface of a railing by means of fasteners 18 (shown in exploded fashion), double sided tape 20, or similar means. The face bar 2 mates with the mounting bar 3. A snap connector 23 connects the power converter 32 to the first light bar assembly 1, providing power for the light sources. The face bar and mounting bar 3 may be various lengths and number according to the set-up to be utilized.

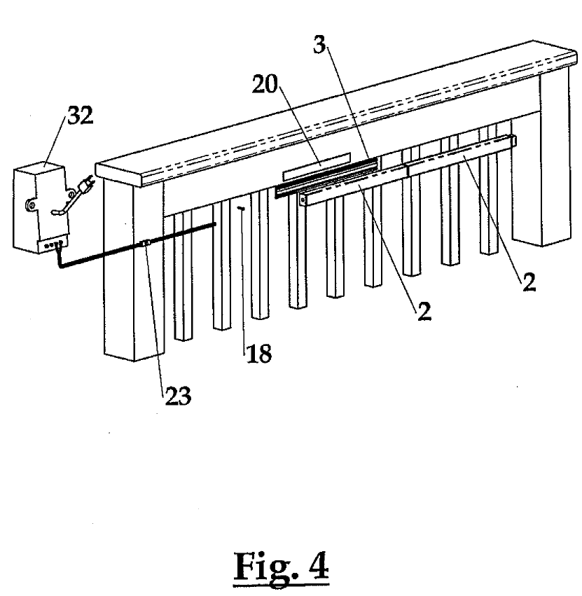

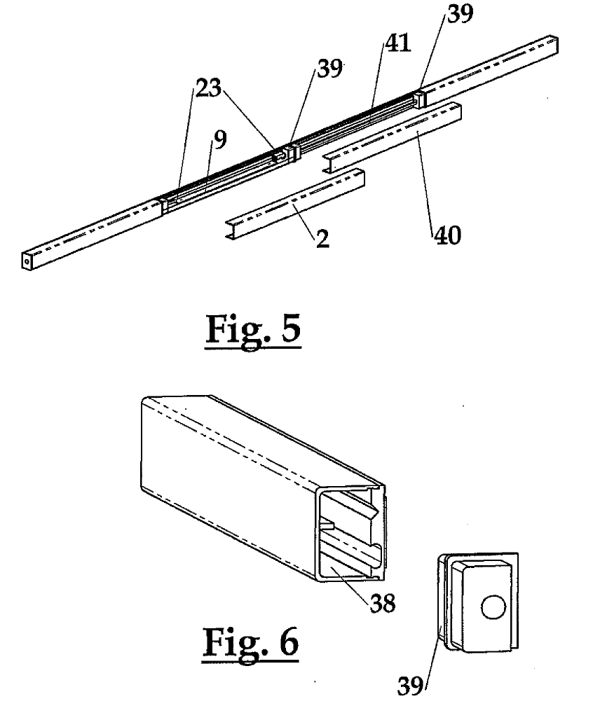

With reference to FIG. 5, further mounting bars 3 can be installed in line with the first such mounting bar 3 until the section is completed. A first face bar 2 is then snapped onto the mounting bar 3 at the location desired for light. In addition, a single elongated mounting bar 3 may accommodate more than one face bar 2, if desired. After connection has been completed, a connector plug 39, as shown in FIGS. 5 and 6, is pushed into the hollow end 38 of either adjacent light bar assembly 1, before the two assemblies are tightly pushed together. The connector plug 39 has a hole through which electrical wires may pass.

Any space that does not require lighting can optionally be covered with an empty face bar 40 that is shaped identically to face bar 2, but does not contain any electrical components. If a distance between light bar assemblies 1 or between sections has to be bridged, a suitable electrical wire 41 can be used, either left open or covered by the space bar 40. In either situation, electrical wire 41 is connected to the last used light bar assembly 1 and the first used light bar assembly 1 of a new section by means of snap connector 23.

With reference to FIG. 7, a further embodiment is shown to provide power to the light bar assembly 1. A supply plug 37 which connects to a converter/power source can be mated with an end of a light bar assembly 1. The supply plug 37 can optionally incorporate an optical sensor, timing device, or other technology to control power to the light bar assembly 1.

Although the invention has been shown as a light bar assembly used for a deck railings, many other applications exist for the invention, such as steps, overhangs, fencing and more, many of which are regulated by code which requires appropriate lighting.

Further, while the present invention has been described above in terms of various embodiments, it is to be understood that the invention is not limited to these disclosed embodiments and is also capable of a wide variety of further and other embodiments within the spirit and scope of the appended claims. It is intended that the scope of the invention should be determined by those of skill in the art relying upon the disclosure in this specification and the attached drawings.

What is claimed is:

1. A light bar assembly, comprising:
a face bar extending in a longitudinal direction and having a pair of ends, a portion thereof forming a connecting section and another portion thereof having at least one opening therein for permitting light to pass therethrough;
a lighting system mounted within said face bar, said lighting system comprising:
a circuit board extending in the longitudinal direction and having two ends and having wires capable of carrying electric current;
at least one light source electrically connected to said wires and said circuit board; and
the at least one light source being optically aligned with said at least one opening of said face bar to permit light to be directed out of said face bar;
a mounting bar extending in the longitudinal direction and having two ends, a portion thereof forming a connecting section; said mounting bar being capable of being mounted to a structure, and said connecting section of said face bar and said connecting section of said mounting bar being removably interconnected to each other.

2. The light bar assembly of claim 1 wherein said connecting section of said mounting bar is adapted to allow an upper snapping mechanism of said face bar to be engaged before rotating and pushing a lower snapping mechanism of said face bar into place; wherein said face bar comprises at least two segments forming a space for affixing said lighting system therein; and wherein said at least one opening of said face bar is located on either segment.

3. The light bar assembly of claim 1 wherein said at least one light source is an LED.

4. The light bar assembly of claim 1 wherein said connecting section of said face bar and said connecting section of said mounting bar are removably connected via a snap fastening system.

5. The light bar assembly of claim 1 wherein said mounting bar comprises an indentation therein to receive said wires of said lighting system.

6. The light bar assembly of claim 1 wherein said face bar comprises at least two segments which include said connecting section, and said at least two segments forming a space for affixing said lighting system therein.

7. The light bar assembly of claim 6 wherein said lighting system is at least partially encased in a water-resistant substance.

8. The light bar assembly of claim 7 wherein said face bar comprises three segments forming a channel for housing said lighting system therein.

9. The light bar assembly of claim 1 wherein said mounting bar and said face bar have openings therein to receive a fastening element to mount said mounting bar and said face bar to another structure.

10. The light bar assembly of claim 1 wherein said mounting bar has an adhesive surface to mount said mounting bar to another structure.

11. The light bar assembly of claim 1 wherein said face bar and said mounting bar are made of plastic.

12. The light bar assembly of claim 6 wherein said at least one opening to pass light therethrough is on a bottom of said at least two segments.

13. The light bar assembly of claim 12 wherein said mounting bar is mounted vertically.

14. The light bar assembly of claim 6 wherein said mounting bar is mounted horizontally.

15. The light bar assembly of claim 1 further comprising a snap connector, whereby said snap connector interconnects two wires of said circuit board with another set of two wires.

16. The light bar assembly of claim 15 wherein said connecting section of said mounting bar is adapted to allow an upper snapping mechanism of said face bar to be engaged before rotating and pushing a lower snapping mechanism of said face bar into place; wherein said face bar comprises at least two segments forming a space for affixing said lighting system therein; and wherein said at least one opening of said face bar is located on either segment.

17. The light bar assembly of claim 16 further comprising a connector plug having a first end and a second end, whereby the first end fits snugly into an end of said face bar and the second end can fit snugly into an end of another face bar, thus physically connecting two light bar assemblies together.

18. The light bar assembly of claim 17 wherein a series of light bar assemblies interconnected together form a light bar system.

19. The light bar system of claim 18 further comprising a supply plug, wherein said supply plug fits snugly into an end of said face bar and electrically connects said circuit board to a power source.

20. The light bar system of claim 19 further comprising a light sensor.

21. The light bar system of claim 20 further comprising a timing device.

22. A light bar system comprising:
a plurality of light bar assemblies interconnected to each other, each of said light bar assemblies comprising:
a face bar extending in a longitudinal direction and having a pair of ends, a portion thereof forming a connecting section and another portion thereof having at least one opening therein for permitting light to pass therethrough;
a lighting system mounted within said face bar, said lighting system comprising:
a circuit board extending in the longitudinal direction and having two ends and having wires capable of carrying electric current;
at least one light source electrically connected to said wires and said circuit board; and
the at least one light source being optically aligned with said at least one opening of said face bar to permit light to be directed out of said face bar;
said face bar comprising at least two members which include said connecting section, and said at least two segments forming a space therein for affixing said lighting system therein; and
said lighting system is at least partially encased in a water-resistant substance; and
a mounting bar extending in the longitudinal direction and having two ends, a portion thereof forming a connecting section; said mounting bar being capable of being mounted to a structure, and said connecting section of said face bar and said connecting section of said mounting bar being removably interconnected to each other;
a connector plug having a first end and a second end, whereby the first end fits snugly into an end of said face bar and the second end can fit snugly into an end of another face bar, thus physically connecting two light bar assemblies together; and
a supply plug, wherein said supply plug fits snugly into an end of said face bar and electrically connects said circuit board to a power source.

23. The light bar system of claim 22 wherein said connecting section of said mounting bar is adapted to allow an upper snapping mechanism of said face bar to be engaged before rotating and pushing a lower snapping mechanism of said face bar into place; wherein said face bar comprises at least two segments forming a space for affixing said lighting system therein; and wherein said at least one opening of said face bar is located on either segment.

24. The light bar system of claim 23, further comprising a light sensor.

25. The light bar system of claim 23 further comprising a timing device.

26. The light bar system of claim 23 wherein said mounting bar comprises an indentation therein to receive said wires of said lighting system.

27. The light bar system of claim 23 wherein said mounting bar is mounted vertically.

28. The light bar system of claim 23 wherein said mounting bar is mounted horizontally.

29. The light bar system of claim 23 wherein at least one of said light bar assemblies has a face bar having no lighting system therein.
